(19) United States
(12) Patent Application Publication
(10) Pub. No.: US 2026/0044742 A1
(43) Pub. Date: Feb. 12, 2026

(54) TEXT-TO-IMAGE USING LOW RANK ADAPTATION DIFFUSION

(71) Applicant: VINAI ARTIFICIAL INTELLIGENCE APPLICATION AND RESEARCH JOINT STOCK COMPANY, Ha Noi (VN)

(72) Inventors: Tuan Trung Dao, Ha Noi (VN); Hoang Thuan Nguyen, Ha Noi (VN); Van Thanh Le, Ha Noi (VN); Hong Duc Vu, Ha Noi (VN); Duc Minh Khoi Nguyen, Ha Noi (VN); Van Cuong Pham, Ha Noi (VN); Tuan Anh Tran, Ha Noi (VN); Hai Hung Bui, Ha Noi (VN)

(21) Appl. No.: 19/003,286

(22) Filed: Dec. 27, 2024

Related U.S. Application Data
(60) Provisional application No. 63/681,648, filed on Aug. 9, 2024.

(51) Int. Cl. G06N 3/096; G06N 3/0464; G06T 11/00

(52) U.S. Cl. CPC G06N 3/096; G06N 3/0464; G06T 11/00

(57) ABSTRACT

Distilling a pretrained multi-step text to image diffusion teacher model to a one-step student model includes initiating a first modeling process by a first student model based on a text-based user prompt of an image the user wants to be drawn. The user prompt is sent to a first convolutional neural network (CNN) and to a low rank adaption diffusion model. The first CNN and the low rank adaption diffusion model generate a first latent output. A second modeling process is initiated by a second student model based on the user prompt. A second CNN generates a second latent output. A third student model is generated by merging an output of the first student model with an output of the second student model. The third student model is the one-step student model.

### CROSS-REFERENCE TO RELATED APPLICATION

This application claims benefit under 35 U.S.C. § 119(e) of U.S. Provisional Application having Ser. No. 63/681,648 filed Aug. 9, 2024, which is hereby incorporated by reference herein in its entirety.

### FIELD OF THE INVENTION

The present invention relates in general to diffusion modeling. More particularly, the invention is directed to a text-to-image system using low rank adaptation (LoRA) diffusion.

### BACKGROUND OF THE INVENTION

Recently, one-step diffusion models have emerged as a promising approach for fast and efficient text-to-image generation. However, these models often struggle to match the quality and diversity of their multi-step counterparts. Conventional one-step text-to-image diffusion models are typically derived from a form of distillation originating from multi-step diffusion models. However, these one-step student models often exhibit inferior performance compared to their teacher counterparts due to the inherent limitations of the distillation process.

### SUMMARY OF THE INVENTION

In a first aspect, a method of distilling a pretrained multi-step text to image diffusion teacher model to a one-step student model is provided. The method includes initiating a first modeling process by a first student model based on a user prompt. The user prompt is a text-based request of an image the user wants to be drawn. The user prompt is sent to a first convolutional neural network and to a low rank adaption diffusion model. The first convolutional neural network obtains a plurality of data sets. The first convolutional neural network and the low rank adaption diffusion model generate a first latent output from the data sets, according to the user prompt. The first student model is trained using a first feedback. A second modeling process is initiated by a second student model based on the user prompt. The user prompt is sent to a second convolutional neural network. A second latent output is generated by the second convolutional neural network. The second student model is trained using a second feedback. A third student model is generated by merging an output of the first student model with an output of the second student model. The third student model is the one-step student model.

In a second aspect, a computer program product for distilling a pretrained multi-step text to image diffusion teacher model to a one-step student model is provided. The computer program product includes a non-transitory computer readable storage medium having program instructions. An execution of the program instructions cause a processor to initiate a first modeling process by a first student model based on a user prompt. The user prompt is a text-based request of an image the user wants to be drawn. The user prompt is sent to a first convolutional neural network and to a low rank adaption diffusion model. The first convolutional neural network obtains a plurality of data sets. The first convolutional neural network and the low rank adaption diffusion model generate a first latent output from the data sets, according to the user prompt. The first student model is trained using a first feedback. A second modeling process is initiated by a second student model based on the user prompt. The user prompt is sent to a second convolutional neural network. A second latent output is generated by the second convolutional neural network. The second student model is trained using a second feedback. A third student model is generated by merging an output of the first student model with an output of the second student model. The third student model is the one-step student model.

In a third aspect, a computing device is provided. The computing device includes a processor and a memory coupled to the processor. The memory stores instructions that cause the processor to perform acts including initiating a first modeling process by a first student model based on a user prompt. The user prompt is a text-based request of an image the user wants to be drawn. The user prompt is sent to a first convolutional neural network and to a low rank adaption diffusion model. The first convolutional neural network obtains a plurality of data sets. The first convolutional neural network and the low rank adaption diffusion model generate a first latent output from the data sets, according to the user prompt. The first student model is trained using a first feedback. A second modeling process is initiated by a second student model based on the user prompt. The user prompt is sent to a second convolutional neural network. A second latent output is generated by the second convolutional neural network. The second student model is trained using a second feedback. A third student model is generated by merging an output of the first student model with an output of the second student model. The third student model is a one-step student model.

These and other features and advantages of the invention will become more apparent with a description of preferred embodiments in reference to the associated drawings.

### DESCRIPTION OF THE DRAWINGS

FIG. 1 is a block diagram of a system for generating text-to-image modeling in accordance with an embodiment of the subject technology.

FIG. 2 is a block diagram of a modeling architecture in accordance with an embodiment of the subject technology.

FIG. 3 is a flowchart of a method for training a text-to-image model in accordance with an embodiment of the subject technology.

### DETAILED DESCRIPTION OF THE PREFERRED EMBODIMENTS

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

### Overview

In general, and referring to the Figures, embodiments provide a system and method for image-free score distillation that uses low rank adaptation (LoRA) diffusion. Embodiments use a resource-efficient training scheme, that embeds inside a novel clamped CLIP loss that enhances image-text alignment, resulting in improved image quality. Remarkably, by combining the weights of models trained with efficient finetuning and full training, a new state-of-the-art one-step diffusion model is provided achieving a Fréchet inception distance (FID) of 8.14 and surpassing all GAN-based and multi-step Stable Diffusion models. General parts of the subject technology include the following:
In-training improvements: This section of the subject technology analyzes the scaling law governing the relationship between dataset size and performance in the subject distillation method. Furthermore, it addresses the text-alignment weakness inherent in this distillation scheme by introducing auxiliary loss functions and additional techniques to enhance control over the distillation process.
Resource-efficient training scheme: The subject technology does not solely focus on advancing the state of one-step diffusion methods but also prioritizes resource efficiency. By incorporating a resource-efficient training scheme, the integration of auxiliary loss functions does not significantly impact GPU memory usage or training time, allowing the improved distillation scheme to maintain roughly the same resource requirements as previous methods.
Post-training improvements: Given two or more models, methods of the subject technology combine the models' strengths without compromising memory usage or computational efficiency. To achieve this, a model merging scheme is proposed, which begins with an empirical analysis of the synergy between the two models during weight interpolation. This analysis reveals the existence of an optimal weight combination that allows the merged, final model to surpass the performance of both original models. Finally, the merging scheme is applied to the fully fine-tuned model and the resource-efficient fine-tuned model to create the final model, which leverages the best aspects of both approaches while maintaining resource efficiency.

“SwiftBrush” as used herein, refers to a distillation technique for training a one-step text-to-image diffusion model from a pre-trained multi-step text-to-image model that is based on variational score distillation and requires no training images. The distillation technique includes:
An auto-encoder which is used to compress an image to a smaller latent and decompress it;
A student diffusion-based text-to-image model which is trained to predict clean latent in one step;
A pretrained diffusion-based multi-step text-to-image teacher model which is used to guide the distillation of the student model; and
A LoRA diffusion-based multi-step text-to-image teacher model which is trained in parallel with the student model to bridge the gap between the student model and the pretrained teacher.

### System Architecture

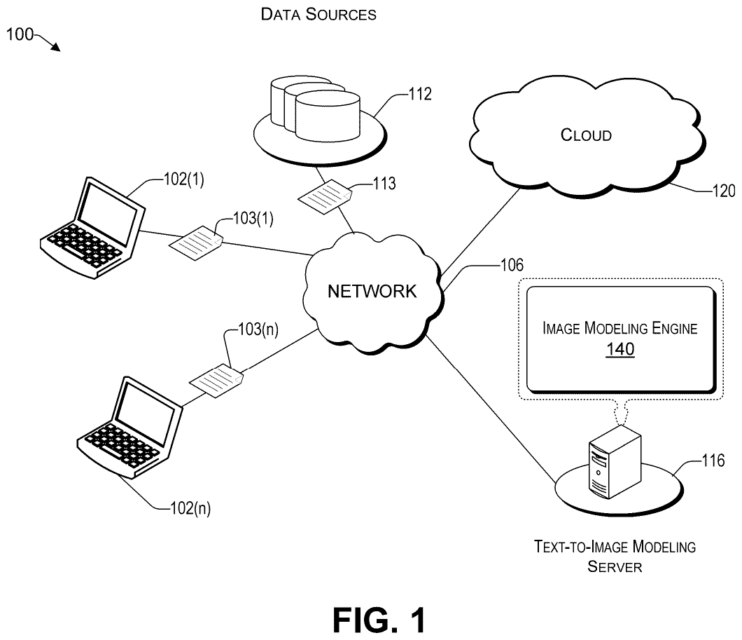

FIG. 1 shows a system 100 (referred to generally below as the “system 100” or just the “system”) for generating text-to-image modeling according to an embodiment. The system 100 generally includes one or more computing device nodes 102(1) . . . 102(n) connected through a network 106 to a data sources 112. Other elements connected to the network 106 and to the computing device nodes 102(1) . . . 102(n), include a text-to-image modeling server 116, and in some embodiments, the cloud 120.

The text-to-image modeling server 116 may include an image modeling engine 140 providing prediction modeling using the techniques described below. The network 106 allows the image modeling engine 140, which is a software program running on text-to-image modeling server 116, to communicate with the data source 112, computing device nodes 102(1) . . . 102(n), and/or the cloud 120, to provide data processing of text prompts to generate images. The data sources 112 may include source data used to generate initial prediction models and historical data to train models for generating image output. Embodiments may include training sets of real images that can be used to train models for generating wholly new images from features within the training set images. Input from computing device nodes 102(1) . . . 102(n) may take the form of data packets 103(1) . . . 103(n) that are transferred into the network 106 and forwarded to the data sources 112 for retrieval of stored data 113, and/or the text-to-image modeling server 116, and or the cloud 120 for processing of input to generate modeling and/or image generation. In one embodiment, the data processing is performed at least in part within the cloud network 120. The text-to-image modeling server 116 may use models described below to generate an output from a prompt received by any one of the components of the computing device nodes 102(1) . . . 102(n). The output of the text-to-image modeling server 116 from a prompt is generally an image that represents the information in the prompt. In another embodiment, the output from the text-to-image modeling server 116 may be an improved one-step diffusion-based text-to-image prediction model that is generated from the merging of two training models.

The components of the computing device nodes 102(1) . . . 102(n) and server 116 may include, but are not limited to, one or more computer processors, a system memory, data storage, and a computer program product having a set of program modules including files and executable instructions performing any one or more of the methods included in this disclosure. The computing devices may typically include a variety of computer system readable media. Such media could be chosen from any available media that is accessible including non-transitory, volatile and non-volatile media, removable and non-removable media for use by or in connection with an instruction execution system, apparatus, or device. The system memory may include one or more computer system readable media in the form of volatile memory, such as a random-access memory (RAM) and/or a cache memory.

As will be appreciated by one skilled in the art, aspects of the disclosed technology may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “module”, “circuit”, or “system.” In addition, some embodiments below are described with reference to block diagrams of methods, apparatus (systems) and computer program products. It will be understood that each block of the block diagrams, and combinations of blocks in the flowchart illustrations and/or block diagrams, can be implemented by computer program instructions. These computer program instructions may be provided to the processor/controller 105, such that the instructions, which execute via the processor of the computer or other programmable data processing apparatus, create means for implementing the functions/acts specified in the flowchart and/or block diagram block or blocks in the figures.

### Modeling Architecture and Methodology

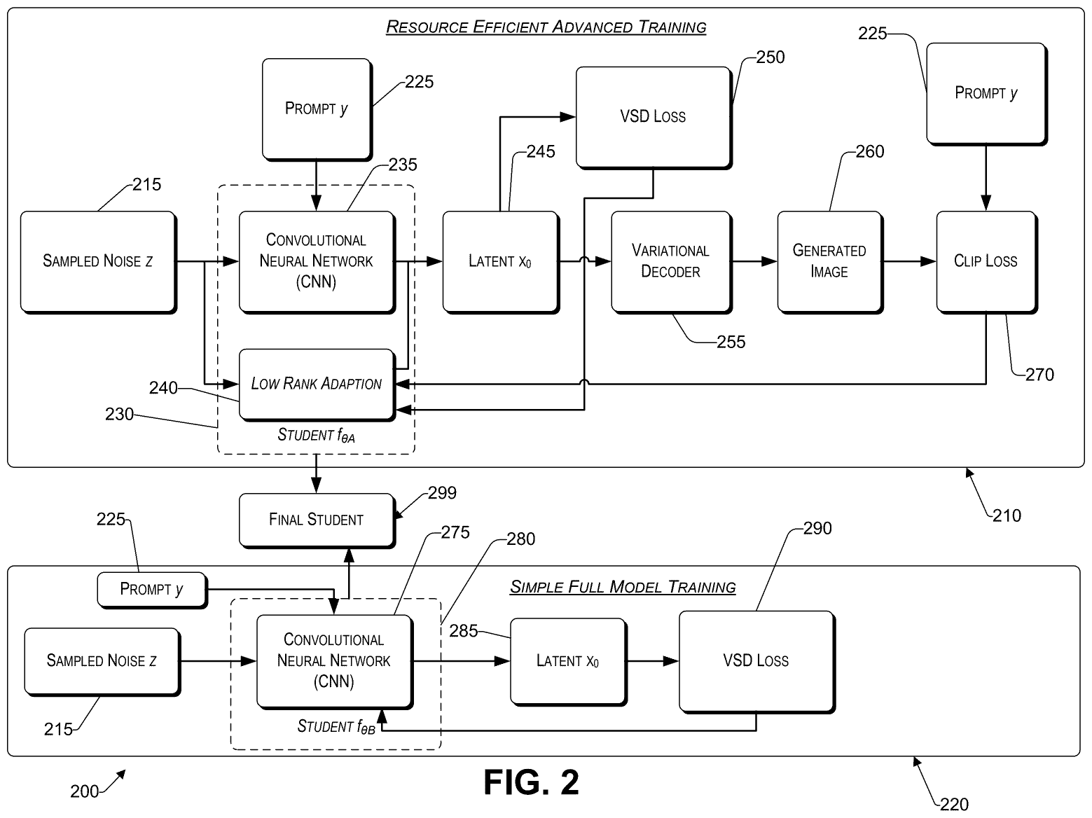

FIG. 2 shows a modeling architecture 200 according to an embodiment that generates a visual output from a text-based input. The modeling architecture 200 generally includes two training models: a resource efficient advanced training model 210 and a simple full training model 220. The output from the resource efficient advanced training model 210 and the simple full training model 220 are merged to generate a final student model 299 that is used to generate images from prompt inputs 225. The architecture 200 is generally present and its elements are generally performed as modules in the image modeling engine 140 shown in FIG. 1.

In one embodiment, the resource efficient advanced training model 210 includes a student model 230. The student model 230 may initiate its modeling based on a prompt 225. The prompt 225 may be a text-based prompt that describes an image a user wants to be drawn. For example, a user may request a “realistic photo of a cat sleeping on a tabletop”. The student model 230 may include a convolutional neural network (CNN) 235 that is connected to a LoRA diffusion module 240. The CNN 235 may obtain data sets to process the prompt 225 from a library or other database of records (for example, the data sources 112 shown in FIG. 1). In some embodiments, a set of sampled noise data 215 may be provided to the student model 230 as part of the modelling process. In some applications the added noise may reduce for example, generalization error and/or overfitting. The output from student model 230 may be trained by a Variational Score Distillation (VSD) loss 250 sampling value. In some embodiments, a clip loss 270 may be used to train the output from the student model 230. Clip loss 270 compares the output generated image 260 and the input prompt 225. Hence, the prompt 225 and the output generated image 260 are shown as inputs to the clip loss 270. A latent embedding 245 produced by the student model 230 may be fed or forwarded to a variational decoder 255. “Latent” as used herein, is an abstract and compact representation of the image used by the diffusion model. An image can be converted to its latent embedding using a variational encoder, and converted from a latent embedding to the corresponding image using a variational decoder. An image 260 is generated from the output of the variational decoder 255.

In one embodiment, the full training model 220 includes a student model 280. The student model 280 may initiate its modeling based on the same prompt 225 used by the student model 230. The student model 280 may use a CNN 275 to perform modelling using data sets from a library. The latent output 285 of the student model 280 may be trained by a VSD loss 290 sampling value. The VSD loss 250 and VSD loss 290 may use the same formula, however the VSD loss for each student model may result in a different outcome given the different elements of each student model. The output from the student model 230 is merged with the output from the student model 280 to generate a final student model 299. In one embodiment, the final student model 299 is generated by averaging together the weights of the student model 230 and the student model 280.

The subject technology allows an easy means to scale up training data by collecting more prompt inputs 225. Although the scope of work can be large, given the abundance of textual datasets and the availability of large language models (which may be stored in the data sources 112), the task of processing all the data is simplified by the proposed methodology, (as compared to the costly and labor-intensive task of collecting image-text pair data commonly required in conventional schemes). Embodiments of the modeling architecture may not force the output of the student model to be the same as that of the teacher, which allows the student to go beyond the quality and capability of the teacher. However, in some embodiments, extra auxiliary loss functions may be added during training.

As will be appreciated, the subject technology's image-free approach allows for scalable training datasets without limitations. To explore the dataset's impact on the subject technology's performance, supplementary experiments were conducted by augmenting the dataset with an additional 2M prompts from the LAION dataset to the original 1.5M deduplicated prompts from the JourneyDB dataset. Analysis reveals improved performance with the expanded dataset. Specifically, this leads to a significant improvement in terms of FID and precision, suggesting a positive correlation between dataset size and the quality of the generated outputs. However, a slight degradation in recall was observed, indicating a potential trade-off between image diversity and overall quality. Furthermore, despite an increase in CLIP score compared to the previous version, there remains room for improvements in terms of text alignment.

Referring back to FIG. 2, two versions of the student model are shown: a fully finetuned model (the simple full training model 220) trained with the VSD loss 290, and a LoRA finetuned model (the resource efficient advanced training model 210), trained with both VSD loss 250 and CLIP loss 270. The final model 299 (represented by,

$${θ}_{merged} = {λθ}_{A} + ( 1 - λ ) {θ}_{B}$$

is obtained by merging the two student models 210 and 220, leveraging the strengths of both training schemes.

### Tackling the Text to Alignment Problem

To refine the coherence between textual prompts and visual outputs, an additional CLIP loss may be integrated within the distillation process. However, naively employing such loss between the student model's predictions and the original textual prompts poses challenges, as over-optimizing for the CLIP score potentially degrades image quality. This highlights a key limitation in using CLIP loss for distillation: prioritizing textual alignment over visual fidelity. To address this, the CLIP value may be clamped during training with ReLU activation. This aims to balance text alignment with preserving image quality, ensuring the model maintains visual integrity. Additionally, dynamic scheduling may be introduced to control the influence of CLIP loss, gradually reducing its weight to zero by the end of distillation. This balanced approach integrates visual-textual alignment and image fidelity effectively. Our clamped CLIP loss is formulated as:

$${ℒ}_{CLIP} = max ( 0 , τ - ( {ℰ}_{image} ( 𝒟 ( {f}_{θ} ( z , y ) ) ) , {ℰ}_{text} ( y ) ) ) ,$$

where ε_{image} and εₜₑₓₜ represent the CLIP image and text encoders, respectively. [symbol] is the VAE decoder used to map the latent back to the image. The term t introduces a threshold on the desired cosine similarity [symbol] ⋅,⋅ [symbol] between the image and text embeddings, preventing the model from overemphasizing textual alignment at the expense of image quality.

The subject approach reflects a nuanced understanding of the intricate balance required in the distillation process, particularly when integrating cross-modal alignment techniques such as CLIP. By addressing the limitations of a straightforward CLIP loss application, the underlying method not only improves text-image alignment but also maintains, if not enhances, the overall quality of the generated images.

By leveraging text prompts exclusively, the distilled student model can achieve significantly higher recall rates than traditional distillation methods. This remarkable capability stems from its liberation from the spatial constraints typically imposed by reconstruction loss, allowing for enhanced creative freedom in generating images.

Despite these benefits, the absence of guidance from the real image distribution introduces challenges in maintaining the quality of the distilled images. To address this challenge, some embodiments integrate reconstruction loss as a regularizer into the distillation framework for enhancing the fidelity of generated images to their real counterparts. It ensures that the distilled model captures the original images' high-level semantic essence and faithfully reproduces the intricate details and textural nuances characteristic of actual imagery. By directly comparing predicted images with real images, reconstruction loss serves as a helpful feedback mechanism. It steers the student model towards achieving outputs that are semantically consistent and visually indistinguishable from genuine photographs. This strategy elevates the generated images' quality, guaranteeing more authentic and lifelike outputs.

### Resource-Efficient Training Schemes

While CLIP loss is highly beneficial, it comes with memory and computation costs. Particularly, the CLIP image encoder can only work on image space, requiring decoding the predicted latent to image via the image decoder [symbol] as can be seen in

$${ℒ}_{CLIP} = max ( 0 , τ - ( {ℰ}_{image} ( 𝒟 ( {f}_{θ} ( z , y ) ) ) , {ℰ}_{text} ( y ) ) ) ,$$

By incorporating CLIP loss into full-model distillation, the training speed is slowed down, particularly on GPUs with moderate VRAM. The resource-efficient training scheme of the subject technology is used to fully exploit the proposed CLIP loss in a constrained setting without sacrificing the training speed on memory-constrained hardware.

It is possible to significantly reduce memory requirements during fine-tuning with the LoRA framework, where only a set of small-rank parameters are trained. Also, to compute the CLIP loss, the predicted latent 245 goes through a large VAE decoder 255, increasing training length and memory consumption. To address this, some embodiments use for example TinyVAE which sacrifices some fine detail in images but preserves overall structure and object identity comparable to the original VAE. This approach maintains training efficiency close to those of the original fully fine-tuned model.

To harmonize the benefits of the image-free distillation schema and spatial loss, the subject method includes selectively applying reconstruction loss to a minor set of the image-text prompt pair dataset-approximately 5% of the total dataset, while only fine-tuning the one-step diffusion model. This targeted application occurs sporadically alongside the original image-free distillation process, designed to strike a delicate balance between maintaining the efficiency and broad generative capabilities of image-free distillation, while still capturing the nuanced details and authenticity that reconstruction loss offers. By focusing on a small, representative subset of the dataset and partially update the model weights, the method ensures that the model benefits from the detailed guidance provided by reconstruction loss without the computational burden and potential overfitting, ultimately causing recall degradation. Moreover, this strategy allows for the distilled model to adaptively improve its ability to generate high-fidelity images, refining its performance over time through targeted feedback. This methodical integration not only preserves the unique strengths of both distillation techniques but also fosters a synergistic improvement in the quality and diversity of the generated images, setting a new benchmark for efficiency and effectiveness in model distillation processes.

The subject method combines fine-tuned iterations of models to create an enhanced model for one-step text-to-image diffusion models. These models, although designed for the same task, differ in their training objectives, providing each with unique advantages. By merging the models (210 and 220 referenced above), a new model 299 is generated that captures the strength of each model 210; 220 without increasing model size or inference costs. Given two one-step diffusion models with weights θ_{A} and θ_{B} and an interpolation weight λ, the weights may be merged using a linear interpolation of the weights:

$${θ}_{merged} = {λθ}_{A} + ( 1 - λ ) {θ}_{B}$$

where θ_{A} represents the weight of the resource efficient advanced training model 210 using LoRA teacher 240, trained using for example, Tiny VAE and utilizing VSD loss 250 and CLIP loss 270; and θ_{B} signifies the weight of the fully finetuned student model 220 employing VSD loss 290 exclusively.

The benefit of such interpolation scheme is demonstrated with SD Turbo, known for its precision and strong text alignment, and the original SwiftBrush, which excels in diversity. In the empirical analysis, it is observed that by interpolating from one model to the other, all evaluated metrics (except for the CLIP score) show improvement at some optimal point. This indicates that the fused model potentially outperforms the original models. These findings underscore the potential of model fusion techniques in enhancing model efficacy, as evidenced by the metric analysis.

In some embodiments, the subject technology may use two training schemes. Either the student model is trained with LoRA 240 and TinyVAE (255) utilizing VSD loss 250 and CLIP loss 270 or the student model 220 is fully finetuned employing only VSD loss 290. These two training schemes lead to two resulting one-step models with different behaviors, making them ideal ingredients for merging. By merging these models, the final model output 299 is generated for the subject training framework.

### Training Methodology

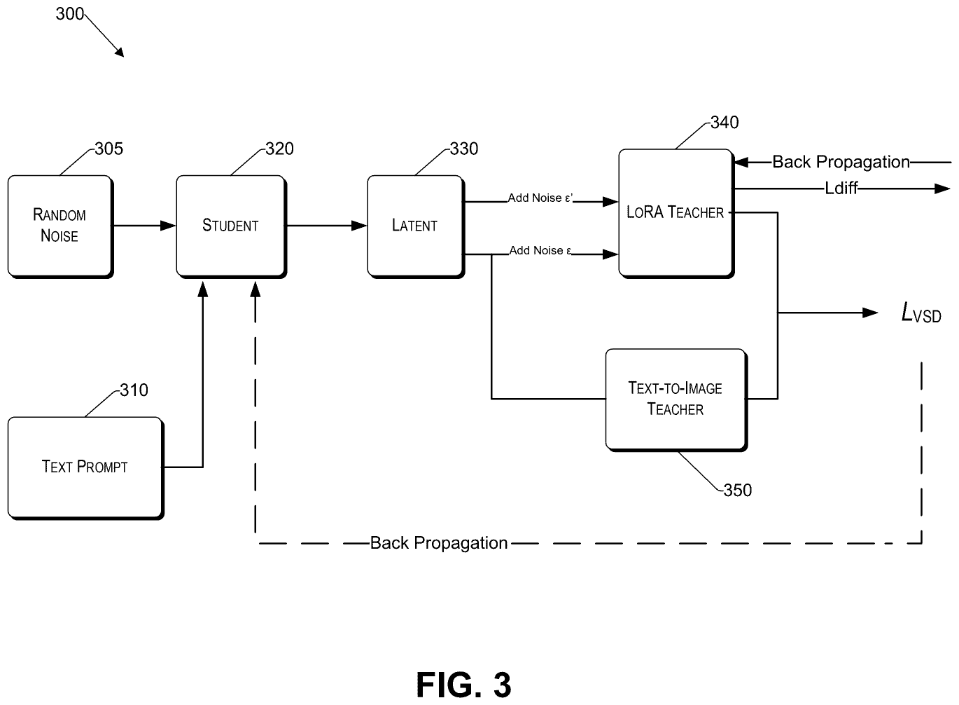

Referring to FIG. 3, an example training method 300 of for generating a visual output from a text-based input may include the student model 320 receives random noise 305 and a text prompt 310, then outputs a clean latent 330 that matches with the given text prompt 310. “Clean latents” are latent embeddings corresponding to normal images, including images in training data and desired images to generate. In diffusion model training, clean images are computed from training images and then noise is added, and the model is trained to denoise the noise infused latents. At inference time, given a random noise as the input latent, the diffusion model will denoise it to get a clean latent that can be decoded to the output image. For example, a random noise may be added to the latent 330 estimated by the student model 320 to get a noisy latent which is then used as input to the pretrained teacher model 350 and LoRA teacher model 340. Each teacher model 340 and 350 takes in the noisy latent 330 and the text prompt 310, and then estimates the added noise. The outputs of both the pretrained teacher model 350 and LoRA teacher model 340 are used to compute the loss (for example, the VSD loss and/or the clip loss) for training the student model 320. For example, in one embodiment, a gradient of variational score distillation (VSD) loss is determined from a comparison of outputs from the LoRA diffusion teacher and the pre-trained teacher module. “Gradient” in this context refers to the gradient for the weights (parameters) of the student network. The gradient is a derivative of the loss function with respect to the weights (parameters) of the student model. The gradient of VSD loss is fed back to the student network. The LoRA diffusion teacher may be updated alternatingly with a diffusion loss, wherein in the first model training, the student model is fully finetuned, and in the second model training, the student model is partially finetuned using LoRA and one extra clamped CLIP loss. The first and second trained models may be combined by averaging together their weights.

Those of skill in the art would appreciate that various components and blocks may be arranged differently (e.g., arranged in a different order, or partitioned in a different way) all without departing from the scope of the subject technology. The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Thus, the claims are not intended to be limited to the aspects shown herein, but are to be accorded the full scope consistent with the language of claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method of distilling a pretrained multi-step text to image diffusion teacher model to a one-step student model, comprising:
initiating a first modeling process by a first student model based on a user prompt, wherein the user prompt is a text-based request of an image the user wants to be drawn;
sending the user prompt to a first convolutional neural network and to a low rank adaption diffusion model;
obtaining, by the first convolutional neural network, a plurality of data sets;
generating a first latent output from the data sets, by the first convolutional neural network and by the low rank adaption diffusion model, according to the user prompt;
training the first student model using a first feedback;
initiating a second modeling process by a second student model based on the user prompt;
sending the user prompt to a second convolutional neural network;
generating a second latent output by the second convolutional neural network;
training the second student model using a second feedback; and
generating a third student model by merging an output of the first student model with an output of the second student model, wherein the third student model is the one-step student model.

2. The method of claim 1, wherein the generation of the third student model further comprises averaging a first set of weight values of the first student model with a second set of weight values of the second student model.

3. The method of claim 1, further comprising:
computing a first Variational Score Distillation (VSD) loss sampling value from the first latent output; and wherein
the feedback used to train the first student model includes using the first VSD loss sampling value.

4. The method of claim 3, further comprising:
computing a second VSD loss sampling value from the second latent output; and wherein
the feedback used to train the second student model includes using the second VSD loss sampling value.

5. The method of claim 1, further comprising:
forwarding the first latent output to a variational decoder; and
generating an image output from the variational decoder.

6. The method of claim 5, further comprising:
determining a clip loss from the image output; and wherein
the feedback used to train the first student model includes using the clip loss.

7. The method of claim 1, further comprising adding noise data to the first student model and/or to the second student model.

8. A computer program product for distilling a pretrained multi-step text to image diffusion teacher model to a one-step student model, the computer program product comprising a non-transitory computer readable storage medium having program instructions embodied therewith, wherein an execution of the program instructions cause a processor to:
initiate a first modeling process by a first student model based on a user prompt, wherein the user prompt is a text-based request of an image the user wants to be drawn;
send the user prompt to a first convolutional neural network and to a low rank adaption diffusion model;
obtain, by the first convolutional neural network, a plurality of data sets;
generate a first latent output from the data sets, by the first convolutional neural network and by the low rank adaption diffusion model, according to the user prompt;
train the first student model using a first feedback;
initiate a second modeling process by a second student model based on the user prompt;
send the user prompt to a second convolutional neural network;
generate a second latent output by the second convolutional neural network;
train the second student model using a second feedback; and
generate a third student model by merging an output of the first student model with an output of the second student model, wherein the third student model is the one-step student model.

9. The computer program product of claim 8, wherein the generation of the third student model further comprises averaging a first set of weight values of the first student model with a second set of weight values of the second student model.

10. The computer program product of claim 8, wherein the execution of the program instructions further causes the processor to:
compute a first Variational Score Distillation (VSD) loss sampling value from the first latent output; and wherein
the feedback used to train the first student model includes using the first VSD loss sampling value.

11. The computer program product of claim 10, wherein the execution of the program instructions further causes the processor to:
compute a second VSD loss sampling value from the second latent output; and wherein
the feedback used to train the second student model includes using the second VSD loss sampling value.

12. The computer program product of claim 8, wherein the execution of the program instructions further causes the processor to:
forward the first latent output to a variational decoder; and
generate an image output from the variational decoder.

13. The computer program product of claim 12, wherein the execution of the program instructions further causes the processor to:
determine a clip loss from the image output; and wherein
the feedback used to train the first student model includes using the clip loss.

14. The computer program product of claim 8, wherein the execution of the program instructions further causes the processor to add noise data to the first student model and/or to the second student model.

15. A computing device, comprising:
a processor; and
a memory coupled to the processor, the memory storing instructions to cause the processor to perform acts comprising:
initiating a first modeling process by a first student model based on a user prompt, wherein the user prompt is a text-based request of an image the user wants to be drawn;
sending the user prompt to a first convolutional neural network and to a low rank adaption diffusion model;
obtaining, by the first convolutional neural network, a plurality of data sets;
generating a first latent output from the data sets, by the first convolutional neural network and by the low rank adaption diffusion model, according to the user prompt;
training the first student model using a first feedback;
initiating a second modeling process by a second student model based on the user prompt;
sending the user prompt to a second convolutional neural network;
generating a second latent output by the second convolutional neural network;
training the second student model using a second feedback; and
generating a third student model by merging an output of the first student model with an output of the second student model, wherein the third student model is a one-step student model.

16. The computing device of claim 15, wherein the generation of the third student model further comprises averaging a first set of weight values of the first student model with a second set of weight values of the second student model.

17. The computing device of claim 15, wherein the instructions cause the processor to perform further acts comprising:
computing a first Variational Score Distillation (VSD) loss sampling value from the first latent output; and wherein
the feedback used to train the first student model includes using the first VSD loss sampling value.

18. The computing device of claim 17, wherein the instructions cause the processor to perform further acts comprising:
computing a second VSD loss sampling value from the second latent output; and wherein
the feedback used to train the second student model includes using the second VSD loss sampling value.

19. The computing device of claim 15, wherein the instructions cause the processor to perform further acts comprising:
forwarding the first latent output to a variational decoder; and
generating an image output from the variational decoder.

20. The computing device of claim 19, wherein the instructions cause the processor to perform further acts comprising:
determining a clip loss from the image output; and wherein
the feedback used to train the first student model includes using the clip loss.
